(19) United States
(12) Patent Application Publication
(10) Pub. No.: US 2026/0036860 A1
(43) Pub. Date: Feb. 5, 2026

(54) ELECTRIC-FIELD RESPONSIVE PARTICLE, MANUFACTURING METHOD THEREOF, AND ELECTROPHORETIC MEDIUM

(71) Applicants: NATIONAL UNIVERSITY CORPORATION CHIBA UNIVERSITY, CHIBA-SHI (JP); Tianma Japan, Ltd., Kawasaki (JP)

(72) Inventors: Tatsuo TANIGUCHI, CHIBA-SHI (JP); Ryoya TAKAHASHI, CHIBA-SHI (JP); Mamoru OKAMOTO, Kawasaki (JP); Tetsuro TASHIRO, Kawasaki (JP)

(73) Assignees: NATIONAL UNIVERSITY CORPORATION CHIBA UNIVERSITY, CHIBA-SHI (JP); Tianma Japan, Ltd., Kawasaki (JP)

(21) Appl. No.: 19/287,890

(22) Filed: Aug. 1, 2025

(30) Foreign Application Priority Data
Aug. 2, 2024 (JP) 2024-127632

(51) Int. Cl. G02F 1/1516; G02F 1/153; G02F 1/155

(52) U.S. Cl. CPC G02F 1/15165; G02F 1/1533; G02F 1/155

(57) ABSTRACT

Disclosed are an electric-field responsive particle, a manufacturing method thereof, and an electrophoretic medium. The electric-field responsive particle includes carbon black, a first polymer that includes a functional group with a positive charge, and a linking group that connects the carbon black and the first polymer. The linking group includes an ester group, and the electric-field responsive particle is positively charged in a liquid medium.

### CROSS-REFERENCE TO RELATED APPLICATIONS

This application claims the benefit of Japanese Patent Application No. 2024-127632, filed on Aug. 2, 2024, the entire disclosure of which is incorporated by reference herein.

### FIELD OF THE INVENTION

The present disclosure relates to an electric-field responsive particle, a manufacturing method thereof, and an electrophoretic medium.

### BACKGROUND OF THE INVENTION

Industrial devices such as bank automatic teller machines (ATMs) have attracted much interest in prevention of peep of an operation panel from behind (shoulder hacking). The recent spread of portable terminals such as laptops, smartphones, and tablets increases a demand for peep prevention from the perspective of privacy protection.

As peep prevention technologies developed to date, several methods have been proposed based on viewing angle limitation technologies. For example, in a method of newly designing a liquid crystal display itself, a switch liquid crystal layer is disposed on the upper portion of a liquid crystal main panel. In this method, the switch liquid crystal layer can be switched on and off, but does not necessarily have a strong shielding property. As for a relatively inexpensive product, there is a film with light shields arranged in a micro-louvered pattern. This film has an excellent shielding property, but if shielding is unnecessary, the film is required to be removed. Therefore, it is expected to realize a privacy filter allowing a shielding function to be switched on and off and having an excellent shielding property.

Here, carbon black has excellent light-shielding and heat resistance properties and superior black color, and is thus expected to be used as electrophoretic particles in a privacy filter. However, carbon black alone is electrically neutral, and thus it is difficult to achieve electric-field responsiveness.

In addition, carbon black dispersion plays an important role in realization of a privacy filter that can be switched on and off and has an excellent light-shielding property. However, carbon black dispersion has a problem in that carbon black is highly cohesive and does not necessarily high dispersion stability in various solvents. Moreover, there is a problem in that, to impart an electrophoretic mobility to carbon black, the amount of charge introduced is required to be increased.

As a method for introducing polymer chains to a carbon black surface, for example, Literature 1 (Advances in Polymer Technology, 2021, 5591420, 11 pages, 2021) discloses a method in which carbon black is coated with poly dopamine and atom transfer radical polymerization is then performed. Literature 2 (Journal of Materials Chemistry A, 2014, 2, 16039) discloses a method in which a carbon black surface is oxidized and atom transfer radical polymerization is then performed. However, electric-field responsiveness of carbon black is not evaluated in these methods.

Thus, there is a need for carbon black with electric-field responsiveness.

In addition, electric-field responsive particles using carbon black are required for electronic paper or equivalent devices as well as privacy filters.

### SUMMARY OF THE INVENTION

An electric-field responsive particle according to a first aspect of the present disclosure includes:
carbon black;
a first polymer including a functional group with a positive charge; and
a linking group connecting the carbon black and the first polymer, wherein
the linking group includes an ester group, and
the electric-field responsive particle is positively charged in a liquid medium.

An electric-field responsive particle according to a second aspect of the present disclosure includes:
carbon black;
a first polymer including a functional group with a positive charge;
a linking group connecting the carbon black and the first polymer; and
a second polymer laminated on the first polymer and including a functional group with a negative charge, wherein
the linking group includes an ester group,
the second polymer is electrostatically adsorbed to the first polymer, and
the electric-field responsive particle is negatively charged in a liquid medium.

An electric-field responsive particle according to a third aspect of the present disclosure includes:
carbon black;
a first polymer including a functional group with a positive charge;
a linking group connecting the carbon black and the first polymer;
a second polymer laminated on the first polymer and including a functional group with a negative charge; and
a third polymer laminated on the second polymer and including a functional group with a positive charge, wherein
the linking group includes an ester group,
the second polymer is electrostatically adsorbed to the first polymer,
the third polymer is electrostatically adsorbed to the second polymer, and
the electric-field responsive particle is positively charged in a liquid medium.

A manufacturing method of an electric-field responsive particle according to a fourth aspect of the present disclosure is a manufacturing method of the electric-field responsive particle according to the first aspect of the present disclosure, and the manufacturing method includes:
converting a carboxyl group on a carbon black surface to a polymerization initiating group including an ester group; and
synthesizing a first polymer including a functional group with a positive charge by initiating a polymerization reaction from the polymerization initiating group.

A manufacturing method of an electric-field responsive particle according to a fifth aspect of the present disclosure is a manufacturing method of the electric-field responsive particle according to the second aspect of the present disclosure, and the manufacturing method includes:
converting a carboxyl group on a carbon black surface to a polymerization initiating group including an ester group;
synthesizing a first polymer including a functional group with a positive charge by initiating a polymerization reaction from the polymerization initiating group; and
causing a second polymer including a functional group with a negative charge to be electrostatically absorbed to the first polymer.

A manufacturing method of an electric-field responsive particle according to a sixth aspect of the present disclosure is a manufacturing method of the electric-field responsive particle according to the third aspect of the present disclosure, and the manufacturing method includes:
converting a carboxyl group on a carbon black surface to a polymerization initiating group including an ester group;
synthesizing a first polymer including a functional group with a positive charge by initiating a polymerization reaction from the polymerization initiating group;
causing a second polymer including a functional group with a negative charge to be electrostatically absorbed to the first polymer; and
causing a third polymer including a functional group with a positive charge to be electrostatically absorbed to the second polymer.

An electrophoretic medium according to a seventh aspect of the present disclosure includes:
the electric-field responsive particle according to any one of the first aspect to the third aspect of the present disclosure; and
a solvent in which the electric-field responsive particle is dispersed.

It is to be understood that both the foregoing general description and the following detailed description are exemplary and explanatory and are not restrictive of this disclosure.

### BRIEF DESCRIPTION OF DRAWINGS

FIG. 1 is a drawing schematically illustrating a structure of each of electric-field responsive particles according to Embodiment 1;

FIG. 2 is a drawing schematically illustrating a surface of each of the electric-field responsive particles according to Embodiment 1;

FIG. 3 is a drawing schematically illustrating a structure of each of electric-field responsive particles according to Embodiment 2;

FIG. 4 is a drawing schematically illustrating a surface of each of the electric-field responsive particles according to Embodiment 2;

FIG. 5 is a drawing schematically illustrating a structure of each of electric-field responsive particles according to Embodiment 3;

FIG. 6 is a drawing schematically illustrating a surface of each of the electric-field responsive particles according to Embodiment 3;

FIG. 7 is a drawing schematically illustrating a structure of an active louver using an electrophoretic medium including electric-field responsive particles;

FIG. 8 is a drawing schematically illustrating the structure of the active louver using the electrophoretic medium including the electric-field responsive particles;

FIG. 9 illustrates an electrophoresis experiment of the electric-field responsive particles, in which A1 illustrates an initial state, and A2 to A6 each illustrate a state when a predetermined time has elapsed;

FIG. 10 illustrates an electrophoresis experiment of the electric-field responsive particles, in which B1 illustrates an initial state, and B2 to B9 each illustrate a state when a predetermined time has elapsed; and

FIG. 11 illustrates an electrophoresis experiment of the electric-field responsive particles, in which C1 illustrates an initial state, and C2 to C9 each illustrate a state when a predetermined time has elapsed.

### DETAILED DESCRIPTION OF THE INVENTION

Hereinafter, electric-field responsive particles, a manufacturing method thereof, and an electrophoretic medium including the electric-field responsive particles according to embodiments are described with reference to the drawings.

### Embodiment 1

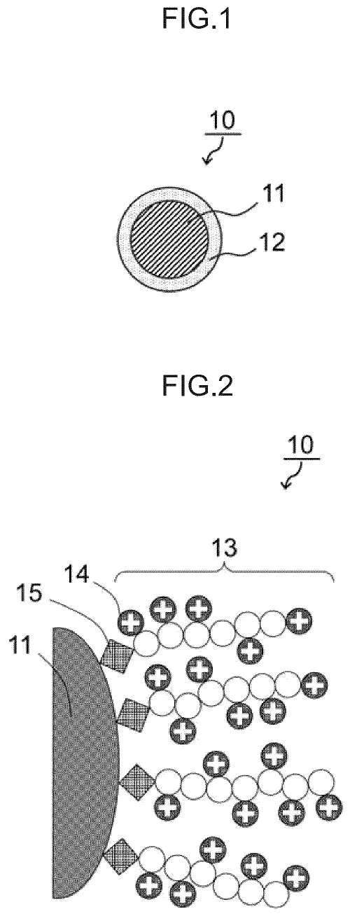

As illustrated in FIG. 1, electric-field responsive particles 10 according to the present embodiment each include a core 11 and a first layer 12 that is disposed on the core 11. As described later, the core 11 is carbon black, and the first layer 12 includes a first polymer 13. Although FIG. 1 illustrates an example of a case where the electric-field responsive particles 10 have a circular cross-sectional shape, the electric-field responsive particles 10 of the present embodiment may have any shape.

As schematically illustrated in FIG. 2, the first polymer 13 included in the first layer 12 is a polymer including a functional group 14 with a positive charge. Since the first polymer 13 includes the functional group 14 with the positive charge, the first layer 12 that is disposed on the outermost layer is positively charged as a whole and thus the electric-field responsive particles 10 each have a positive charge in a liquid medium. Therefore, the electric-field responsive particles 10 have a property responsive to an electric field in the liquid medium. The electric-field responsive particles of the present embodiment are defined as particles migrating to one electrode when a voltage is applied. As described later, use of this property allows control of a dispersion state and an agglomeration state of electric-field responsive particles in a liquid medium by turning application of a voltage on and off. Between the core 11 and the first polymer 13, a linking group 15 is disposed to connect the core 11 and the first polymer 13. One end of the linking group 15 is bonded to the core 11 by a covalent bond, and the other end of the linking group 15 is bonded to the first polymer 13 by a covalent bond. Thus, the first polymer 13 is chemically bonded to the core 11 via the linking group 15, and charge separation (release of charged components) is less likely to occur in the electric-field responsive particles 10.

### Core 11

In the present embodiment, carbon black is used as the core 11. The carbon black is nanoparticles of carbon. The carbon black may have any shape. The carbon black generally includes spherical particles as the smallest unit, and is known to have a complex structure with some of the particles adhering to each other, which is referred to as a structure. The shape of the carbon black is not limited to the spherical shape described in the present embodiment, and the structure thereof may be elliptical or polygonal. The carbon black includes a carboxyl group on a surface thereof. As described later, the electric-field responsive particles 10 of the present embodiment can be efficiently manufactured by converting this carboxyl group to a polymerization initiating group.

### First Polymer 13

In the present embodiment, the first polymer 13 included in the first layer 12 is a polymer including the functional group 14 with the positive charge (in the present disclosure, the functional group with the positive charge included in the first polymer may be referred to as “functional group A”). The electric-field responsive particles 10 may include one type of the first polymer 13, or may include two or more types of the first polymer 13.

Examples of the functional group A include an ammonium group, a pyridinium group, a sulfonium group, and a phosphonium group. Among these examples, the ammonium group is preferable, and a quaternary ammonium group is more preferable for easily forming the positively charged first layer 12. The functional group A may interact with a counter ion to form a salt. Examples of the counter ion include a fluoride ion, a chloride ion, a bromide ion, an iodide ion, a tetrafluoroborate ion, a hexafluorophosphate ion, and a methyl sulfate ion.

Examples of the first polymer 13 include a polymer including a repeating unit represented by the following formula (I) (hereinafter, this repeating unit may be referred to as “repeating unit (1)”). In the present embodiment, some hydrogen atoms in chemical formulas may be omitted.

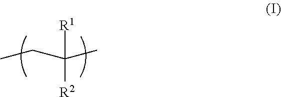

In formula (I), R¹ represents a hydrogen atom or an alkyl group with one to five carbons, and R² represents a group including the functional group A.

Examples of the alkyl group represented by R¹ in formula (I) and having one to five carbons include a methyl group, an ethyl group, an n-propyl group, an isopropyl group, an n-butyl group, an isobutyl group, an s-butyl group, and a t-butyl group. R¹ is preferably the hydrogen atom, the methyl group, or the ethyl group.

Examples of the group represented by R² in formula (I) and including the functional group A include a group represented by the following formula (II) and a group represented by the following formula (III).

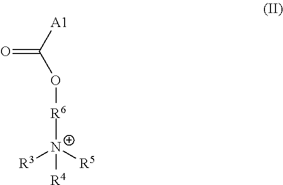

In formula (II), R³ to R⁵ each independently represent a hydrogen atom, or a hydrocarbon group including no substituted group or a substituted group and having one to ten carbons. Two of R³ to R⁵ may be bonded to each other to form a ring. R⁶ represents a divalent hydrocarbon group with two to ten carbons. A1 represents a bonding hand with a polymeric main chain. The hydrocarbon group represented by any of R³ to R⁵ and including no substituted group or a substituted group has one to ten carbons, and preferably has one to five carbons. Examples of the hydrocarbon group represented by any of R³ to R⁵ and including no substituted group include alkyl groups such as a methyl group, an ethyl group, an n-propyl group, and an isopropyl group, aralkyl groups such as a benzyl group, and aryl groups such as a phenyl group and a naphthyl group. Examples of the substituted group included in the hydrocarbon group represented by any of R³ to R⁵ and including the substituted group include hydroxyl groups, alkoxy groups such as a methoxy group and an ethoxy group, and halogen atoms such as a fluorine atom, a chlorine atom, and a bromine atom. Examples of the divalent hydrocarbon group represented by R⁶ and having two to ten carbons include an ethylene group, a 1,2-propylene group, a trimethylene group, and a tetramethylene group.

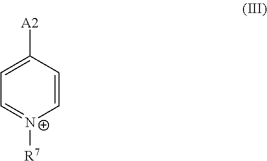

In formula (III), R⁷ represents a hydrogen atom, or a hydrocarbon group including no substituted group or a substituted group and having one to ten carbons. A2 represents a bonding hand with a polymeric main chain. The hydrocarbon group represented by R⁷ and including no substituted group or a substituted group has one to ten carbons, and preferably has one to five carbons. Examples of the hydrocarbon group represented by R⁷ and including no substituted group include alkyl groups such as a methyl group, an ethyl group, an n-propyl group, and an isopropyl group, aralkyl groups such as a benzyl group, and aryl groups such as a phenyl group and a naphthyl group. Examples of the substituted group included in the hydrocarbon group represented by R⁷ and including the substituted group include hydroxyl groups, alkoxy groups such as a methoxy group and an ethoxy group, and halogen atoms such as a fluorine atom, a chlorine atom, and a bromine atom.

Preferable examples of the repeating unit (1) of the first polymer 13 include repeating units represented by the following formulas (I-a) to (I-d). In these repeating units, Me represents a methyl group and Et represents an ethyl group.

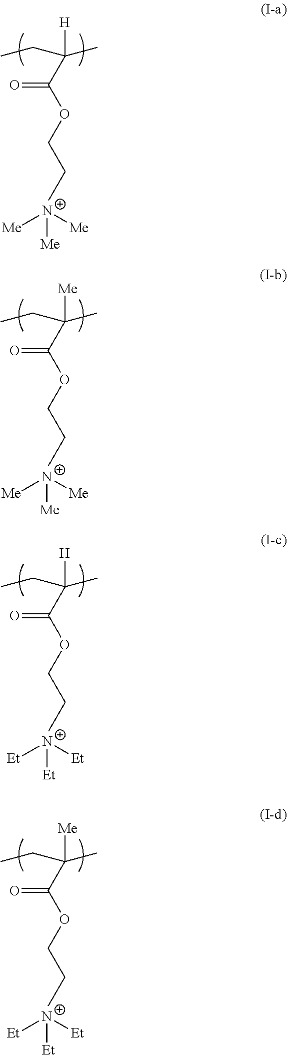

The first polymer 13 may include one type of the repeating unit (1), or may include two or more types of the repeating unit (1).

The first polymer 13 may include a repeating unit other than the repeating unit (1) (hereinafter, this repeating unit may be referred to as “repeating unit (2)”). Introduction of the repeating unit (2) to the first polymer 13 may allow adjustment of the amount of surface charges of the electric-field responsive particles 10.

Examples of the repeating unit (2) include a repeating unit derived from a multifunctional monomer (a monomer including two or more polymerizable groups), and a repeating unit derived from a monofunctional monomer (a monomer including one polymerizable group) except for the repeating unit (1). Examples of the multifunctional monomer include, for example, ester compounds of (meth)acrylic acid and polyhydric alcohols, such as ethylene glycol di(meth)acrylate, diethylene glycol di(meth)acrylate, 1,6-hexanediol di(meth)acrylate, trimethylolpropane tri(meth)acrylate, pentaerythritol tetra(meth)acrylate, and dipentaerythritol hexa(meth)acrylate, and divinylbenzene. Examples of the monofunctional monomer providing the repeating unit (2) include methyl (meth)acrylate, ethyl (meth)acrylate, and styrene. In the present disclosure, (meth)acrylate indicates acrylate or methacrylate.

The content of the repeating unit (1) is, in the total amount of the repeating unit (1) and the repeating unit (2), preferably 70 mol % to 100 mol %, more preferably 80 mol % to 100 mol %, and further more preferably 90 mol % to 100 mol %.

The degree of polymerization of the first polymer 13 is preferably 10 to 1,000, and more preferably 20 to 500. The degree of polymerization of the first polymer 13 within the above range facilitates manufacturing of the electric-field responsive particles 10 including a large amount of the functional group A and having a sufficient positive charge.

As described later, the first polymer 13 can be efficiently synthesized by a living radical polymerization reaction, such as an atom transfer radical polymerization reaction. For example, the first polymer 13 obtained by an atom transfer radical polymerization reaction and including only the repeating unit (1) as a repeating unit is represented by the following formula (IV).

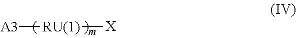

In formula (IV), X represents a halogen atom such as a chlorine atom or a bromine atom, RU(1) represents the repeating unit (1), A3 represents a bonding hand with the linking group 15, and m represents a degree of polymerization.

The amount of the first polymer 13 included in each of the electric-field responsive particles 10 is not specifically limited, but is preferably 5% or more by weight of the carbon black, more preferably 10% or more by weight, and further preferably 15% or more by weight, for example. As the amount of the first polymer 13 included in each of the electric-field responsive particles 10 increases, the electric-field responsive particle 10 includes a larger amount of the functional group A and has a sufficient positive charge. Such electric-field responsive particles 10 have excellent electric-field responsiveness. The maximum value of the amount of the first polymer 13 is not specifically determined, but is preferably 25% or less by weight of the carbon black, for example. The amount of the first polymer 13 can be calculated by, for example, thermal gravimetric analysis (TGA).

### Linking Group 15

In the present embodiment, the linking group 15 is a group connecting the core 11 and the first polymer 13. The linking group 15 includes an ester group. Since the core 11 (the carbon black) includes a carboxyl group on a surface thereof, the ester group can be efficiently generated by using this carboxyl group. As described later, in a case of, when manufacturing the electric-field responsive particles 10, converting the carboxyl group on the carbon black surface to a polymerization initiating group including a halogen atom, and then synthesizing the first polymer 13 initiating from this polymerization initiating group, the linking group 15 is a group with a structure excluding the halogen atom from the polymerization initiating group. Since each of the electric-field responsive particles 10 includes the linking group 15, the first polymer 13 is chemically fixed to the surface of the core 11. Therefore, charge separation is less likely to occur in the electric-field responsive particles 10.

Examples of the linking group 15 include a group represented by the following formula (V).

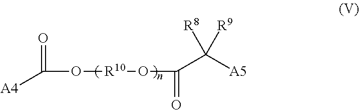

In formula (V), R⁸ and R⁹ each independently represent a hydrogen atom, or a hydrocarbon group including no substituted group or a substituted group and having one to ten carbons. R¹⁰ represents a divalent hydrocarbon group with two to ten carbons. n represents an integer from 1 to 5. When n is 2 or more, a plurality of R¹⁰ may be identical or may be different. A4 represents a bonding hand with the carbon black surface, and A5 represents a bonding hand with the first polymer 13.

The hydrocarbon group represented by R⁸ or R⁹ and including no substituted group or a substituted group has one to ten carbons, and preferably has one to five carbons. Examples of the hydrocarbon group represented by R⁸ or R⁹ and including no substituted group include alkyl groups such as a methyl group, an ethyl group, an n-propyl group, and an isopropyl group, aralkyl groups such as a benzyl group, and aryl groups such as a phenyl group and a naphthyl group. Examples of the substituted group included in the hydrocarbon group represented by R⁸ or R⁹ with the substituted group include hydroxyl groups, alkoxy groups such as a methoxy group and an ethoxy group, and halogen atoms such as a fluorine atom, a chlorine atom, and a bromine atom. Examples of the divalent hydrocarbon group represented by R¹⁰ and having two to ten carbons include an ethylene group, a 1,2-propylene group, a trimethylene group, and a tetramethylene group. n is an integer from 1 to 5, and is preferably 1 or 2, and more preferably 1.

Preferable examples of the linking group 15 include a group represented by the following formula (V-a). In this formula, Me represents a methyl group, and A4 and A5 represent the same as described above.

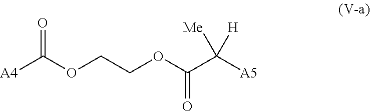

### Electric-Field Responsive Particles 10

The electric-field responsive particles 10 according to the present embodiment are positively charged in a liquid medium, and exhibit electric-field responsiveness. For example, when a voltage is applied to the electric-field responsive particles 10 dispersed in the liquid medium, the electric-field responsive particles 10 move toward a negative electrode and become agglomerated.

The average particle size of the electric-field responsive particles 10 is preferably 10 μm or less, more preferably 1 μm or less, further preferably 500 nm or less, and especially preferably 100 nm or less. The electric-field responsive particles 10 with an average particle size of 10 μm or less have excellent dispersion stability in a liquid medium. In addition, the average particle size of the electric-field responsive particles 10 is preferably 1 nm or more, more preferably 5 nm or more, and further preferably 10 nm or more. The electric-field responsive particles 10 with an average particle size of 1 nm or more have excellent productivity. The polydispersity index (PDI) of the electric-field responsive particles 10 is preferably 0.3 or less. The PDI is an index indicating spread of particle size distribution. Since a dispersant (an electrophoretic medium) of the electric-field responsive particles 10 with a small PDI includes the electric-field responsive particles 10 exhibiting nearly identical electric-field responsiveness, the dispersant is suitably used as an electrophoretic medium for a high-performance active louver. The average particle size and PDI of the electric-field responsive particles 10 are measured in a liquid medium by a dynamic light scattering method. An example of the dynamic light scattering measurement device is nanoSAQLA (manufactured by Otsuka Electronics Co., Ltd.) that includes a semiconductor laser (70 mW) as a light source and an avalanche photodiode (APD) for photo counting as a detector.

The coefficient of variation (CV) value of the electric-field responsive particles 10 is preferably 40% or less, more preferably 35% or less, further preferably 25% or less, and especially preferably 10% or less. The CV value is the coefficient of variation obtained by, in the dynamic light scattering method, dividing a standard deviation based on scattering intensity distribution by the average particle size and then multiplying the divided standard deviation by 100. A dispersant of the electric-field responsive particles 10 with a CV value of 40% or less has an excellent light-shielding property in a dispersion state and agglomeration is less likely to occur.

The zeta potential of the electric-field responsive particles 10 is preferably 5 mV or more, and more preferably 10 mV or more. The maximum value of the zeta potential of the electric-field responsive particles 10 is not specifically determined, but is generally 20 mV or less. The electric-field responsive particles 10 with a zeta potential of 5 mV or more have sufficient electric-field responsiveness.

### Manufacturing Method of Electric-Field Responsive Particles 10

A manufacturing method of the electric-field responsive particles 10 is not specifically limited. The electric-field responsive particles 10 can be efficiently manufactured by using the carboxyl group on the carbon black surface. The carboxyl group may be a carboxyl group originally present on the carbon black surface, or may be a carboxyl group newly generated on the carbon black surface by an oxidation reaction. The oxidation reaction can be performed by using a known method. For example, the carboxyl group can be formed on the carbon black surface by performing oxidation treatment on the carbon black surface using sulfuric acid and potassium permanganate.

In an example of the manufacturing method of the electric-field responsive particles 10, the carboxyl group on the carbon black surface is firstly converted to the polymerization initiating group with the ester group (hereinafter, the polymerization initiating group with the ester group may be referred to as a polymerization initiating group Y). The method for converting the carboxyl group on the carbon black surface to the polymerization initiating group Y is not specifically limited, but a configuration may be provided in which the carboxyl group on the carbon black surface is converted to an acyl chloride group (—COCl), and then the polymerization initiating group Y is formed using a reaction between the acyl chloride group and a hydroxyl group, for example.

For example, when an atom transfer radical polymerization reaction is applied in synthesis of the first polymer 13, the carboxyl group on the carbon black surface can be converted to the polymerization initiating group Y by performing a reaction represented by the following scheme.

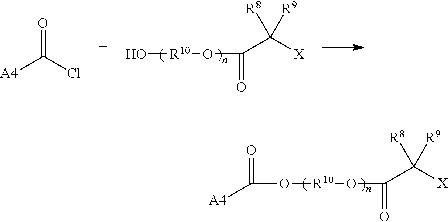

In the above scheme, R⁸ to R¹⁰, n, and A4 represent the same as described above. X represents a halogen atom. Examples of the halogen atom include a chlorine atom and a bromine atom.

After the carboxyl group on the carbon black surface is converted to the polymerization initiating group Y, a polymerization reaction is performed initiating from the polymerization initiating group Y formed on the carbon black surface to synthesize the first polymer 13. The degree of polymerization of the first polymer 13 can be efficiently examined by using a compound including a polymerization initiating group and not bound to the carbon black (hereinafter, referred to as “polymerization initiating group-included compound F”). For example, the polymerization initiating group-included compound F is a compound represented by the following formula (in the formula, R⁸ to R¹⁰, X, and n represent the same as described above) and the first polymer 13 is synthesized with the polymerization initiating group-included compound F present in a reaction system.

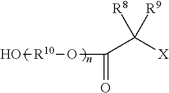

In this case, in the reaction system, a polymerization reaction initiating from the polymerization initiating group Y formed on the carbon black surface and a polymerization reaction initiating from the polymerization initiating group of the polymerization initiating group-included compound F proceed simultaneously. Therefore, the degree of polymerization of the first polymer 13 can be determined by examining the degree of polymerization of a polymer resulting from the polymerization initiating group-included compound F using techniques such as gel permeation chromatography (GPC) and nuclear magnetic resonance (NMR).

The polymerization reaction initiating from the polymerization initiating group Y is preferably a living radical polymerization reaction. Examples of the living radical polymerization reaction include, for example, nitroxide-mediated radical polymerization (NMP), atom transfer radical polymerization (ATRP), and reversible addition fragmentation chain transfer (RAFT) polymerization. Among these examples, the atom transfer radical polymerization reaction is preferable for relatively easily controlling the degree of polymerization of the first polymer 13.

Examples of a transition metal complex used in the atom transfer radical polymerization reaction include a complex containing a transition metal such as ruthenium, iron, nickel, or copper as a central metal and containing 2,2′-bipyridine, N,N,N′,N″,N″-pentamethyldiethylenetriamine, tris(2-pyridylmethyl)amine, tris[2-(N,N-dimethylamino)ethyl]amine, and a derivative thereof as a ligand.

The first polymer 13 can be synthesized by a method in which a polymerization reaction is performed using a monomer including the functional group A, or a method in which a polymerization reaction is performed using a monomer including a functional group to be converted to the functional group A by a chemical reaction (hereinafter, this functional group may be referred to as “functional group A′”) and then the functional group A′ is converted to the functional group A. In any of these methods, the monomer can be used alone, or two or more monomers can be used in combination.

When synthesizing the first polymer 13 as described above, a multifunctional monomer such as ethylene glycol di(meth)acrylate and/or a monofunctional monomer such as methyl(meth)acrylate may be used in combination, as well as the monomer including the functional group A and the monomer including the functional group A′.

When performing a polymerization reaction using the monomer including the functional group A, examples of the monomer including the functional group A include N,N-dimethyl-N-alkyl-N-2-(meth)acryloyloxyethyl ammonium bromide, N,N-diethyl-N-alkyl-N-2-(meth)acryloyloxyethyl ammonium bromide, N-alkyl-N-vinylpyridinium chloride, (meth)acryloyloxyphenyl dimethylsulfonium methylsulfate, and (4-vinylbenzyl)trialkylphosphonium chloride.

When performing a polymerization reaction using the monomer including the functional group A′, examples of the monomer including the functional group A′ include acrylate monomers such as 2-(N,N-dimethylamino)ethyl (meth)acrylate, 2-(N,N-diethylamino)ethyl (meth)acrylate, 3-(N,N-dimethylamino)propyl (meth)acrylate, 3-(N,N-diethylamino)propyl (meth)acrylate, and 2-aminoethyl (meth)acrylate, and vinyl pyridine.

Examples of the method for converting the functional group A′ to the functional group A include a method using alkyl halide. Specifically, the functional group A′ such as an amino group can be converted to the functional group A such as an ammonium group by using the alkyl halide. Examples of the alkyl halide include chloromethane, bromomethane, iodomethane, chloroethane, bromoethane, iodoethane, chloropropane, bromopropane, iodopropane, chlorobutane, bromobutane, and iodobutane. Among these examples, an alkyl halide with one to two carbons is preferable, and iodomethane is more preferable for efficiently converting the functional group A′ to the functional group A.

Among these methods for synthesizing the first polymer 13, a method is preferable that synthesizes a polymer including an amino group using a monomer including the amino group and then converts the amino group to an ammonium group, and a method is more preferable that synthesizes a polymer including a tertiary amino group using a monomer including the tertiary amino group and then converts the tertiary amino group to a quaternary ammonium group.

As a solvent used in the polymerization reaction or the reaction for converting the functional group A′ to the functional group A, a solvent is suitably used that does not adversely affect the reaction, disperses the carbon black, and dissolves the components other than the carbon black. The solvent can be selected and used as appropriate to suit a purpose from among water, alcohol solvents such as methanol, ketone solvents such as acetone, ester solvents such as ethyl acetate, ether solvents such as tetrahydrofuran, amide solvents such as N,N-dimethylformamide, aromatic solvents such as toluene.

### Embodiment 2

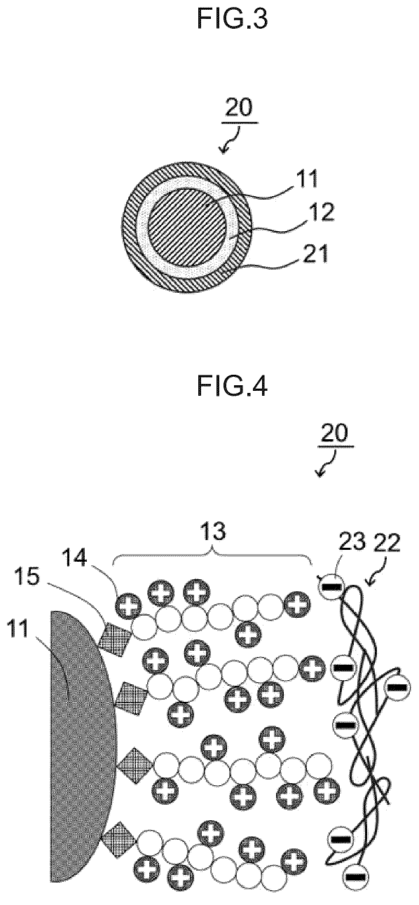

Electric-field responsive particles 20 according to the present embodiment are described with reference to FIGS. 3 and 4. The electric-field responsive particles 20 according to Embodiment 2 differ from the electric-field responsive particles 10 according to Embodiment 1 in that the electric-field responsive particles 20 each include a second layer 21. The parts common with Embodiment 1 are denoted with the same reference signs, and detailed description thereof is omitted.

As illustrated in FIG. 3, the electric-field responsive particles 20 each include the core 11, the first layer 12 that is disposed on the core 11, and the second layer 21 that is laminated on the first layer 12. As described above, the core 11 is the carbon black, and the first layer 12 includes the first polymer 13 that includes the functional group A. As described later, the second layer 21 includes a second polymer 22. As schematically illustrated in FIG. 4, the second polymer 22 included in the second layer 21 is a polymer including a functional group 23 with a negative charge. Since the second polymer 22 includes the functional group 23 with the negative charge, the second layer 21 that is disposed on the outermost layer is negatively charged as a whole and thus the electric-field responsive particles 20 each have a negative charge in a liquid medium. Therefore, the electric-field responsive particles 20 have an electric-field responsive property in the liquid medium.

The amount of the first polymer 13 included in each of the electric-field responsive particles 20 is not specifically limited, but is preferably 5% or more by weight of the carbon black, more preferably 10% or more by weight, and further preferably 15% or more by weight, for example. The amount of the first polymer 13 is preferably 25% or less by weight of the carbon black, and more preferably 20% or less by weight. In each of the electric-field responsive particles 20, the first polymer 13 including the functional group A has an affinitive interaction with the second polymer 22. In addition, the electric-field responsive particles 20 are particles moving toward a positive electrode when a voltage is applied. The amount of the first polymer 13 in each of the electric-field responsive particles 20 is preferably determined considering these balances.

### Second Polymer 22

In the present embodiment, the second polymer 22 included in the second layer 21 is a polymer including the functional group 23 with the negative charge (in the present disclosure, the functional group with the negative charge included in the second polymer may be referred to as “functional group B”). The electric-field responsive particles 20 may include one type of the second polymer 22, or may include two or more types of the second polymer 22. Since the second polymer 22 is a polymer including the functional group B as described above, the second polymer 22 and the first polymer 13 including the functional group A have an electrostatic interaction. In addition, an affinitive interaction such as hydrogen bonding may occur therebetween. These affinitive interactions contribute to stabilization of the second layer 21.

Examples of the functional group B include a carboxylate group, a sulfate group, a sulfonate group, a phosphate group, and a phosphonate group. Among these examples, the sulfonate group is preferable for easily forming the negatively charged second layer 21. The functional group B may interact with a counter ion to form a salt. Examples of the counter ion include an ammonium ion, a sodium ion, and a potassium ion. In the description of the manufacturing process of the electric-field responsive particles 20, “functional group B” does not only mean a group with a negative charge, but also an electrically neutral group (a group in a Brønsted acid state) in which a proton is added to the group with the negative charge.

Examples of the second polymer 22 include a polymer including a repeating unit derived from a monomer including the functional group B. Examples of the monomer including the functional group B include (meth)acrylic acid, styrenesulfonic acid, 2-(meth)acrylamido-2-methylpropanesulfonic acid, 3-((meth)acryloyloxy)propionic acid, and 3-(meth)acryloyloxypropylphosphonic acid.

Examples of the second polymer 22 include a homopolymer of the above monomer including the functional group B or a copolymer using the above monomer including the functional group B. Among these examples, the second polymer 22 is preferably the homopolymer of the above monomer including the functional group B, and more preferably polystyrene sulfonic acid for easily causing the electric-field responsive particles 20 to be negatively charged.

The degree of polymerization of the second polymer 22 is preferably 10 to 1,000, and more preferably 20 to 500.

The amount of the second polymer 22 included in each of the electric-field responsive particles 20 is not specifically limited, but is preferably 10% or more by weight of the carbon black, more preferably 15% or more by weight, and further preferably 20% or more by weight, for example. As the amount of the second polymer 22 included in each of the electric-field responsive particles 20 increases, the electric-field responsive particle 20 includes a larger amount of the functional group B and has a sufficient negative charge. Such electric-field responsive particles 20 have excellent electric-field responsiveness. The maximum value of the amount of the second polymer 22 is not specifically determined, but is preferably 30% or less by weight of the carbon black, for example. The amount of the second polymer 22 can be calculated by, for example, the TGA.

### Electric-Field Responsive Particles 20

The electric-field responsive particles 20 according to the present embodiment are negatively charged in a liquid medium, and exhibit electric-field responsiveness. For example, when a voltage is applied to the electric-field responsive particles 20 dispersed in the liquid medium, the electric-field responsive particles 20 move toward a positive electrode and become agglomerated.

The average particle size of the electric-field responsive particles 20 is preferably 10 μm or less, more preferably 1 μm or less, further preferably 500 nm or less, and especially preferably 100 nm or less. In addition, the average particle size of the electric-field responsive particles 20 is preferably 1 nm or more, more preferably 5 nm or more, and further preferably 10 nm or more. The PDI of the electric-field responsive particles 20 is preferably 0.3 or less. The CV value of the electric-field responsive particles 20 is preferably 40% or less, more preferably 35% or less, further preferably 25% or less, and especially preferably 10% or less. The zeta potential of the electric-field responsive particles 20 is preferably −20 mV or less, and more preferably −40 mV or less.

In each of the electric-field responsive particles 20, the first polymer 13 is chemically fixed to the surface of the core 11. The second polymer 22 and the first polymer 13 have an electrostatic interaction, and further an affinitive interaction such as hydrogen bonding may occur therebetween. Therefore, charge separation is less likely to occur in the electric-field responsive particles 20.

### Manufacturing Method of Electric-Field Responsive Particles 20

A manufacturing method of the electric-field responsive particles 20 is not specifically limited. For example, the electric-field responsive particles 20 can be efficiently manufactured by, after manufacturing the electric-field responsive particles 10 by the above method, electrostatically adsorbing the second polymer 22 to the first polymer 13 included in the first layer 12 of each of the electric-field responsive particles 10.

Specifically, the electric-field responsive particles 20 can be manufactured by mixing and stirring the dispersant of the electric-field responsive particles 10 and a solution of the second polymer 22 to contact the electric-field responsive particles 10 and the second polymer 22. A solvent included in the dispersant of the electric-field responsive particles 10 and the solution of the second polymer 22 is not limited as long as the solvent disperses the electric-field responsive particles 10 and dissolves the second polymer 22. Examples of the solvent include, for example, water, alcohol solvents such as methanol, ketone solvents such as acetone, ester solvents such as ethyl acetate, ether solvents such as tetrahydrofuran, amide solvents such as N,N-dimethylformamide, and aromatic solvents such as toluene.

Particles other than the electric-field responsive particles 10 can be used as intermediates in manufacturing of the electric-field responsive particles 20 as long as the first polymer 13 and the second polymer 22 have a sufficient affinitive interaction. Examples of the particle other than the electric-field responsive particles 10 include particles including the carbon black and the first polymer and having a negative zeta potential. Use of the particles including the carbon black and the first polymer and having the negative zeta potential facilitates manufacturing of the electric-field responsive particles 20 with a large absolute negative zeta potential.

### Embodiment 3

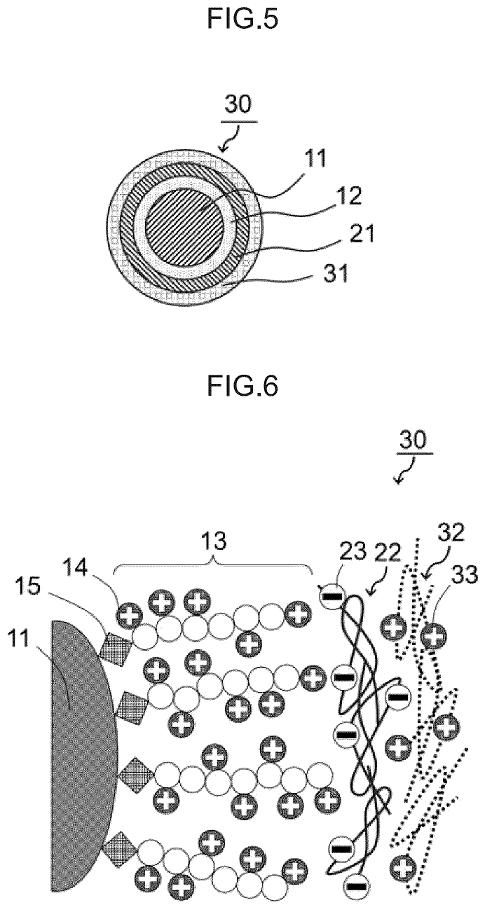

Electric-field responsive particles 30 according to the present embodiment are described with reference to FIGS. 5 and 6. The electric-field responsive particles 30 according to Embodiment 3 differ from the electric-field responsive particles 20 according to Embodiment 2 in that the electric-field responsive particles 30 each include a third layer 31. The parts common with Embodiments 1 and 2 are denoted with the same reference signs, and detailed description thereof is omitted.

As illustrated in FIG. 5, the electric-field responsive particles 30 each include the core 11, the first layer 12 that is disposed on the core 11, the second layer 21 that is laminated on the first layer 12, and the third layer 31 that is laminated on the second layer 21. As described above, the core 11 is the carbon black, the first layer 12 includes the first polymer 13 that includes the functional group A, and the second layer 21 includes the second polymer 22 that includes the functional group B. As described later, the third layer 31 includes a third polymer 32. As schematically illustrated in FIG. 6, the third polymer 32 included in the third layer 31 is a polymer including a functional group 33 with a positive charge. Since the third polymer 32 includes the functional group 33 with the positive charge, the third layer 31 that is disposed on the outermost layer is positively charged as a whole and thus the electric-field responsive particles 30 each have a positive charge in a liquid medium. Therefore, the electric-field responsive particles 30 have an electric-field responsive property in the liquid medium.

The amount of the first polymer 13 included in each of the electric-field responsive particles 30 is not specifically limited, but is preferably 5% or more by weight of the carbon black, more preferably 10% or more by weight, and further preferably 15% or more by weight, for example. The amount of the first polymer 13 is preferably 25% or less by weight of the carbon black, and more preferably 20% or less by weight. The amount of the second polymer 22 included in each of the electric-field responsive particles 30 is not specifically limited, but is preferably 10% or more by weight of the carbon black, more preferably 15% or more by weight, and further preferably 20% or more by weight, for example. The amount of the second polymer 22 is preferably 30% or less by weight of the carbon black, and more preferably 25% or less by weight. In each of the electric-field responsive particles 30, the first polymer 13 including the functional group A and the second polymer 22 including the functional group B affect the interactions between the layers and the charge of the entire particles. Therefore, the amount of the first polymer 13 and the amount of the second polymer 22 in each of the electric-field responsive particles 30 are preferably determined considering these balances.

### Third Polymer 32

In the present embodiment, the third polymer 32 included in the third layer 31 is a polymer including the functional group 33 with the positive charge (in the present disclosure, the functional group with the positive charge included in the third polymer may be referred to as “functional group C”). The electric-field responsive particles 30 may include one type of the third polymer 32, or may include two or more types of the third polymer 32. Since the third polymer 32 is a polymer including the functional group C as described above, the third polymer 32 and the second polymer 22 including the functional group B have an electrostatic interaction. In addition, an affinitive interaction such as hydrogen bonding may occur therebetween. These affinitive interactions contribute to stabilization of the third layer 31.

Examples of the functional group C include an ammonium group, a pyridinium group, a sulfonium group, and a phosphonium group. Among these examples, the ammonium group is preferable, and a quaternary ammonium group is more preferable for easily forming the positively charged third layer 31. The functional group C may interact with a counter ion to form a salt. Examples of the counter ion include a fluoride ion, a chloride ion, a bromide ion, an iodide ion, a tetrafluoroborate ion, a hexafluorophosphate ion, and a methyl sulfate ion. In the description of the manufacturing process of the electric-field responsive particles 30, “functional group C” does not only mean a group with a positive charge, but also an electrically neutral group (a group in a Brønsted base state) in which a proton is removed from the group with the positive charge.

Examples of the third polymer 32 include a polymer including a repeating unit derived from a monomer including the functional group C. Examples of the monomer including the functional group C include allylamine, diallyl dimethyl ammonium chloride, and vinyl benzyl trimethyl ammonium chloride.

Examples of the third polymer 32 include a homopolymer of the above monomer including the functional group C or a copolymer using the above monomer including the functional group C. Among these examples, the third polymer 32 is preferably the homopolymer of the above monomer including the functional group C for easily causing the entire electric-field responsive particles 30 to be positively charged. Examples of the third polymer 32 include polyarylamine hydrochloride (PAH), poly(diallyldimethylammonium chloride) (PDADMAC), poly(vinylbenzyltrimethylammonium chloride), cationic polyethyleneimine, and polyamidine.

The degree of polymerization of the third polymer 32 is preferably 10 to 1,000, and more preferably 20 to 500.

The amount of the third polymer 32 included in each of the electric-field responsive particles 30 is not specifically limited, but is preferably 10% or more by weight of the carbon black, more preferably 15% or more by weight, and further preferably 20% or more by weight, for example. As the amount of the third polymer 32 included in each of the electric-field responsive particles 30 increases, the electric-field responsive particle 30 includes a larger amount of the functional group C and has a sufficient positive charge. Such electric-field responsive particles 30 have excellent electric-field responsiveness. The maximum value of the amount of the third polymer 32 is not specifically determined, but is preferably 30% or less by weight of the carbon black, for example. The amount of the third polymer 32 can be calculated by, for example, the TGA.

### Electric-Field Responsive Particles 30

The electric-field responsive particles 30 according to the present embodiment are positively charged in a liquid medium, and exhibit electric-field responsiveness. For example, when a voltage is applied to the electric-field responsive particles 30 dispersed in the liquid medium, the electric-field responsive particles 30 move toward a negative electrode and become agglomerated.

The average particle size of the electric-field responsive particles 30 is preferably 10 μm or less, more preferably 1 μm or less, further preferably 500 nm or less, and especially preferably 100 nm or less. In addition, the average particle size of the electric-field responsive particles 30 is preferably 1 nm or more, more preferably 5 nm or more, and further preferably 10 nm or more. The PDI of the electric-field responsive particles 30 is preferably 0.3 or less. The CV value of the electric-field responsive particles 30 is preferably 40% or less, more preferably 35% or less, further preferably 25% or less, and especially preferably 10% or less. The zeta potential of the electric-field responsive particles 30 is preferably 5 mV or more, and more preferably 10 mV or more.

In each of the electric-field responsive particles 30, the first polymer 13 is chemically fixed to the surface of the core 11. The second polymer 22 and the first polymer 13 have an electrostatic interaction, and an affinitive interaction such as hydrogen bonding may occur therebetween. In addition, the third polymer 32 and the second polymer 22 have an electrostatic interaction, and an affinitive interaction such as hydrogen bonding may also occur therebetween. Therefore, charge separation is less likely to occur in the electric-field responsive particles 30.

### Manufacturing Method of Electric-Field Responsive Particles 30

A manufacturing method of the electric-field responsive particles 30 is not specifically limited. For example, the electric-field responsive particles 30 can be efficiently manufactured by, after manufacturing the electric-field responsive particles 20 by the above method, electrostatically adsorbing the third polymer 32 to the second polymer 22 included in the second layer 21 of each of the electric-field responsive particles 20.

Specifically, the electric-field responsive particles 30 can be manufactured by mixing and stirring the dispersant of the electric-field responsive particles 20 and a solution of the third polymer 32 to contact the electric-field responsive particles 20 and the third polymer 32. A solvent included in the dispersant of the electric-field responsive particles 20 and the solution of the third polymer 32 is not limited as long as the solvent disperses the electric-field responsive particles 20 and dissolves the third polymer 32. Examples of the solvent include the same as mentioned in the description of the manufacturing method of the electric-field responsive particles 20.

### Electrophoretic Medium

An electrophoretic medium of the present disclosure includes the electric-field responsive particles of any of Embodiments 1 to 3 and the solvent in which these electric-field responsive particles are dispersed. In the electrophoretic medium of the present disclosure, the dispersion state and the agglomeration state of the electric-field responsive particles can be controlled by turning application of a voltage on and off. Thus, a light-shielding property and a shielding property of the electrophoretic medium can be changed by turning application of a voltage on and off.

For example, the electric-field responsive particles of Embodiments 1 and 3 each have a positive charge on a surface thereof, and the electric-field responsive particles of Embodiment 2 each have a negative charge on a surface thereof. Therefore, when no voltage is applied, the electric-field responsive particles tend to maintain a dispersion state due to electrostatic repulsion therebetween. Then, when a voltage is applied to the electric-field responsive particles in this dispersion state, the electric-field responsive particles of Embodiments 1 and 3 move toward the negative electrode and become agglomerated, and the electric-field responsive particles of Embodiment 2 move toward the positive electrode and become agglomerated.

When used as an electrophoretic medium of an active louver or another equivalent device, the particle sizes of the electric-field responsive particles are preferably 10 nm to 10 μm, and more preferably 20 nm to 5 μm. Within this range, a dispersing property tends to be compatible with the light-shielding property and the shielding property.

The concentration of the electric-field responsive particles is preferably 0.01% to 20% by weight, more preferably 2% to 10% by weight, and further preferably 3% to 5% by weight, for example.

A solvent included in the electrophoretic medium is a liquid for dispersing the electric-field responsive particles. The solvent is not specifically limited as long as the solvent disperses the electric-field responsive particles.

Examples of the solvent include, for example, ester solvents such as ethyl acetate, ether solvents such as diethyl ether, ketone solvents such as acetone, alcohol solvents such as methanol, amide solvents such as N,N-dimethylformamide, glycol solvents such as ethylene glycol, isoparaffinic solvents such as isooctane, aromatic hydrocarbon solvents such as methylnaphthalene, ethylbiphenyl, diphenylethane, ethyl benzoate, and benzyl acetate, and halogenated hydrocarbon solvents such as dibromopropane. These solvents can be used alone or two or more of these solvents can be used in combination.

The solvent is preferably an organic solvent with a boiling point of 80° C. or higher. Adoption of the organic solvent with the boiling point of 80° C. or higher prevents volatilization of the solvent during the manufacturing process of the electrophoretic medium and the process of introducing the electrophoretic medium into an electrophoresis cell. In addition, the solvent is preferably an isoparaffinic solvent with a boiling point of 80° C. or higher. Adoption of the isoparaffinic solvent as the solvent improves an insulating property in the electrophoresis cell.

Examples of the isoparaffinic solvent include NAS-3, NAS-4, and NAS-5 (above, manufactured by NOF Corporation), Isoper C, Isoper D, Isoper E, Isoper F, Isoper G, Isoper H, Isoper K, Isoper L, Isoper M, and Isoper V (above, manufactured by Exxon Mobil Corporation), IP Solvent 1016 and IP Clean LX (above, manufactured by Idemitsu Kosan Co., Ltd.), Isosol (manufactured by ENEOS Corporation), and Marcasol R (manufactured by Maruzen Petrochemical Co., Ltd.).

The electrophoretic medium may contain a surfactant. The containment of a surfactant may improve the dispersing property of the electric-field responsive particles. The surfactant is preferably a nonionic surfactant. Examples of the nonionic surfactant include sorbitan trioleate (Span 85). The amount of the surfactant is not specifically limited, but is 1% to 15% by weight of the solvent, for example.

The electrophoretic medium may further contain additives such as a lubricant, a stabilizer, and a dye. The amount of these additives is not specifically limited, and can be determined as appropriate in accordance with the intended use.

The dispersion state and the agglomeration state of the electric-field responsive particles included in the electrophoretic medium of the present disclosure are controlled by turning application of a voltage on and off. Therefore, the light-shielding property and the shielding property of the electrophoretic medium are changed by turning application of a voltage on and off. Because of these properties, the electrophoretic medium of the present disclosure is suitably used as an electrophoretic medium of an active louver exhibiting a light-shielding property or a shielding property.

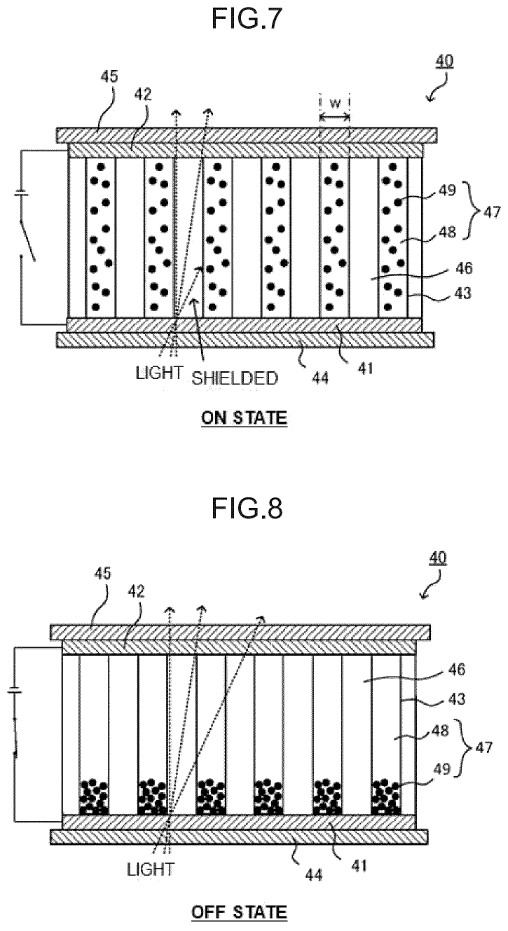

An example is illustrated in FIGS. 7 and 8 in which the electrophoretic medium of the present disclosure is applied to an active louver. An active louver 40 includes a first electrode 41, a second electrode 42 that opposes the first electrode 41, transmission/shielding switchers 43 that are disposed between the first electrode 41 and the second electrode 42, a first substrate 44, and a second substrate 45. The transmission/shielding switchers 43 are arranged in a louvered pattern on a micrometer scale. Transmitters 46 are disposed adjacent to the transmission/shielding switchers 43. The first electrode 41 is disposed on one surface of the first substrate 44, and the second electrode 42 is disposed on one surface of the second substrate 45. All of the first electrode 41, the second electrode 42, the first substrate 44, and the second substrate 45 have a light-transmitting property. The first electrode 41 and/or the second electrode 42 may be patterned to correspond to the transmission/shielding switchers 43. When the second electrode 42 is patterned, the second electrode 42 does not need to have the light-transmitting property. An electrophoretic medium 47 of the present embodiment is disposed in each of the transmission/shielding switchers 43. The active louver 40 is disposed on a non-illustrated display such as a liquid crystal panel, an organic electroluminescence panel, or a micro light emitting diode (LED) panel. In a case of the liquid crystal panel, the active louver 40 can be disposed between the liquid crystal panel and a backlight.

The electrophoretic medium 47 includes a solvent 48 and electric-field responsive particles 49 that are dispersed in the solvent 48. The electrophoretic medium 47 may further contain a surfactant to improve a dispersing property of the electric-field responsive particles 49 in the solvent 48. In the following description, the electric-field responsive particles 49 are assumed to be negatively charged particles.

When no voltage is applied between the first electrode 41 and the second electrode 42, in other words, when a shielding function is an on state, the electric-field responsive particles 49 are dispersed in the solvent 48 as illustrated in FIG. 7. Therefore, a portion of light cannot pass through the transmission/shielding switchers 43 in which the electrophoretic medium 47 is disposed, and thus can be shielded. When a voltage is applied between the first electrode 41 and the second electrode 42, in other words, when the shielding function is an off state, the electric-field responsive particles 49 agglomerate in the vicinity of an electrode to which a positive voltage is applied (the first electrode 41 in FIG. 8). The agglomeration of the electric-field responsive particles 49 on one electrode allows light to pass between the transmission/shielding switchers 43. Thus, the active louver 40 allows the shielding function to be turned on and off, and realizes a privacy filter.

Regardless of the on state illustrated in FIG. 7 or the off state illustrated in FIG. 8, the active louver 40 preferably has a high transmittance of light emitted by the display from the perspective of visibility and prevention of power consumption increase. Therefore, the volume (width) of each of the transmission/shielding switchers 43 that contains the electrophoretic medium 47 is preferably smaller than the volume (width) of each of the transmitters 46 that is adjacent to each of the transmission/shielding switchers 43. The width w of each of the transmission/shielding switchers 43 are set to, for example, 5 μm to 20 μm. To reduce the angular range of light rays transmitted in a narrow view, each of the transmission/shielding switchers 43 preferably has a great height, that is, has a high aspect ratio of height to width. In comparison with electronic paper with respect to an aspect ratio, the electronic paper preferably has a large aperture ratio (equivalent to width) of a pixel containing the electrophoretic medium as a display body. Therefore, a large aspect ratio (a large ratio of height to width) is not necessarily required for the electronic paper, and rather a low aspect ratio (a low ratio of height to width) is desirable from the perspective of thinning. Due to this difference, the privacy filter (the active louver) is required to have a more sensitive electric-field responsiveness because there is a need to travel a short horizontal distance and a long vertical distance. The electric-field responsive particles 10, 20, and 30 of the present embodiment are advantageously used as electrophoretic particles in a privacy filter for easily increasing the absolute value of the zeta potential thereof.

### EXAMPLES

The present disclosure is described below further in detail with illustrative examples. However, these examples are not intended to limit the present disclosure.

### Calculation of Degree of Polymerization of Amino Group-Included Polymer

In Manufacturing Examples 1 to 3, the degree of polymerization of an amino group-included polymer was calculated based on the molecular weight of a polymer using 2-hydroxyethyl 2-bromopropionate as a polymerization initiating molecule. The molecular weight of the polymer using 2-hydroxyethyl 2-bromopropionate as the polymerization initiating molecule was measured by nuclear magnetic resonance (NMR). The conditions for measurement of the degree of polymerization by the NMR are as described below.
Sample: Supernatant fluid obtained by centrifugal separation after atom transfer radical polymerization reaction
Measurement device: Bruker DPX400NMR (manufactured by Bruker Japan K.K.)
Measurement method: The sample was dried and the polymer using 2-hydroxyethyl 2-bromopropionate as the initiating molecule was dissolved in heavy chloroform. The degree of polymerization was determined based on the integrated value of resonance peaks specific for 2-hydroxyethyl 2-bromopropionate and 2-(N,N-dimethylamino)ethyl(meth)acrylate.

### Manufacturing Example 1: Manufacturing of Particles Including Carbon Black and First Polymer with Degree of Polymerization of 25

### (1) Manufacturing of Carbon Black Including Polymerization Initiating Group on Surface Thereof (Polymerization Initiating Group-Included Carbon Black)

1 g of carbon black and 20 mL of tetrahydrofuran (THF) were added to an eggplant flask. 9.83 g of thionyl chloride was added to the flask at 25° C. while stirring the flask contents, and then the flask contents were stirred for one hour. After the reaction was completed, THF was removed under reduced pressure, and the flask contents were further heated under reduced pressure to remove the remaining thionyl chloride.

THF was added to the flask after the removal of thionyl chloride, and further 1.54 g of 2-hydroxyethyl 2-bromopropionate was added to the flask, and the flask contents were stirred at 25° C. for 24 hours. Centrifugal separation was performed on the reaction solution, and the solid contents were washed with pure water three times to obtain polymerization initiating group-included carbon black.

### (2) Manufacturing of Carbon Black Including First Polymer on Surface Thereof (First Polymer-Included Carbon Black)

15 mL of THF was added to an eggplant flask, and 0.98 g of 2-(N,N-dimethylamino)ethyl methacrylate, 13.5 mg of N,N,N′,N″,N″-pentamethyldiethylenediethylenetriamine, and 30.7 mg of 2-hydroxyethyl 2-bromopropionate were dissolved therein. Then, 200 mg of the polymerization initiating group-included carbon black obtained by the above process was added to the flask. Dissolved oxygen was removed by a freeze-pump-thaw cycle. Under nitrogen atmosphere, 11.2 mg of copper bromide was added, and then the flask contents were stirred at 25° C. for 24 hours to perform an atom transfer radical polymerization reaction. The reaction solution was exposed to air, centrifugal separation was further performed, and the solid contents were washed with pure water three times to obtain carbon black including an amino group-included polymer on a surface thereof (amino group-included carbon black). Analysis of the polymer using 2-hydroxyethyl 2-bromopropionate as a polymerization initiating molecule in the solution revealed that the degree of polymerization of the above amino group-included polymer is 25.

60 mL of water and 30 mg of the amino group-included carbon black obtained in the above process were added to the eggplant flask, and the flask contents were stirred to disperse the amino group-included carbon black. Then, 4.56 g of iodomethane was added to the flask, and the flask contents were stirred at 25° C. for 72 hours to convert a dimethylamino group included in the amino group-included carbon black to a trimethylammonium group. Centrifugal separation (14,500 rpm) was performed on the reaction solution, and the solid contents were washed with pure water three times to obtain particles including the carbon black and the first polymer with a degree of polymerization of 25.

### Manufacturing Example 2: Manufacturing of Particles Including Carbon Black and First Polymer with Degree of Polymerization of 100

In the same manner as in Manufacturing Example 1, except that the amount of N,N,N′,N″,N″-pentamethyldiethylenetriamine was changed to 54 mg and the amount of copper bromide was changed to and 44.8 mg, particles including the carbon black and the first polymer with a degree of polymerization of 100 were obtained.

### Manufacturing Example 3: Manufacturing of Particles Including Carbon Black and First Polymer with Degree of Polymerization of 700

In the same manner as in Manufacturing Example 1, except that the amount of 2-(N,N-dimethylamino)ethyl methacrylate was changed to 2.46 g, particles including the carbon black and the first polymer with a degree of polymerization of 700 were obtained.

### Example 1: Manufacturing of Electric-field Responsive Particles 20 Including First Polymer with Degree of Polymerization of 25 (Particles Including Carbon Black, First Polymer, and Second Polymer)

A solution obtained by dissolving 153 mg of sodium polystyrene sulfonate in 15 mL of pure water was dropped into a water dispersant of the particles obtained in Manufacturing Example 1 (the particles including the carbon black and the first polymer with a degree of polymerization of 25), and then the water dispersant was stirred for one hour. Centrifugal separation (14,500 rpm) was performed on the reaction solution, and the solid contents were washed with pure water three times to obtain the electric-field responsive particles 20 including the first polymer with a degree of polymerization of 25.

### Example 2: Manufacturing of Electric-field Responsive Particles 20 Including First Polymer with Degree of Polymerization of 100 (Particles Including Carbon Black, First Polymer, and Second Polymer)

In the same manner as in Example 1, except that the particles obtained in Manufacturing Example 2 (the particles including the carbon black and the first polymer with a degree of polymerization of 100) were used instead of the particles obtained in Manufacturing Example 1 (the particles including the first polymer with a degree of polymerization of 25), the electric-field responsive particles 20 including the first polymer with a degree of polymerization of 100 were obtained.

### Example 3: Manufacturing of Electric-Field Responsive Particles 20 Including First Polymer with Degree of Polymerization of 700 (Particles Including Carbon Black, First Polymer, and Second Polymer)

In the same manner as in Example 1, except that the particles obtained in Manufacturing Example 3 (the particles including the carbon black and the first polymer with a degree of polymerization of 700) were used instead of the particles obtained in Manufacturing Example 1 (the particles including the first polymer with a degree of polymerization of 25), the electric-field responsive particles 20 including the first polymer with a degree of polymerization of 700 were obtained.

### Measurement of Particle Sizes of Electric-Field Responsive Particles

The particle sizes of the particles obtained in Manufacturing Examples 1 to 3 and Examples 1 to 3 are illustrated in Table 1. A measurement device used in measurement of the particle sizes and measurement conditions are as described below. In Table 1, Dh represents an average particle size, and PDI represents a polydispersity index.
Measurement device: nanoSAQLA (manufactured by Otsuka Electronics Co., Ltd.)
Measurement temperature: 25° C.
Integration count: 75

### Zeta Potentials of Electric-Field Responsive Particles

The zeta potentials of the particles obtained in Manufacturing Examples 1 to 3 and Examples 1 to 3 are illustrated in Table 1. A measurement device used in measurement of the zeta potentials and measurement conditions are as described below.
Measurement device: Zeta potential and particle size measurement system (ELSZ-1000ZSCK, manufactured by Otsuka Electronics Co., Ltd.)
Measurement temperature: 25° C.

TABLE 1

| | | Particle Size | | |
|---|---|---|---|---|
| | | Measurement | | Zeta Potential |
| | Particle Composition | Dₕ [mm] | PDI | [mV] |
| Reference Example | Carbon black | 86 | 0.110 | −50.36 |
| Manufacturing | Carbon black | 129 | 0.179 | −31.97 |
| Example 1 | First polymer (degree of | | | |
| | polymerization of 25) | | | |
| Manufacturing | Carbon black | 102 | 0.115 | −25.66 |
| Example 2 | First polymer (degree of | | | |
| | polymerization of 100) | | | |
| Manufacturing | Carbon black | 7073 | 1.367 | Not measurable |
| Example 3 | First polymer (degree of | | | due to |
| | polymerization of 700) | | | agglomeration |
| Example 1 | Carbon black | 158 | 0.109 | −44.79 |
| | First polymer (degree of | | | |
| | polymerization of 25) | | | |
| | Second polymer | | | |
| Example 2 | Carbon black | 216 | 0.367 | −47.34 |
| | First polymer (degree of | | | |
| | polymerization of 100) | | | |
| | Second polymer | | | |
| Example 3 | Carbon black | 129 | 0.109 | −28.86 |
| | First polymer (degree of | | | |
| | polymerization of 700) | | | |
| | Second polymer | | | |

### Electrophoresis of Electric-Field Responsive Particles

An electrophoretic medium was prepared by adding, to an isoparaffinic solvent (Isopar G, manufactured by Exxon Mobil Corporation), the electric-field responsive particles 20 (including the first polymer with a degree of polymerization of 100) obtained in Example 2 and sorbitan trioleate (SPAN 85) to have concentrations of 1% and 5% by weight, respectively. The electrophoretic medium was injected into a comb-shaped electrode cell with an inter-electrode distance (a distance between electrodes 1 and 2) of 90 m and a cell gap of 10 m, using a capillary action.

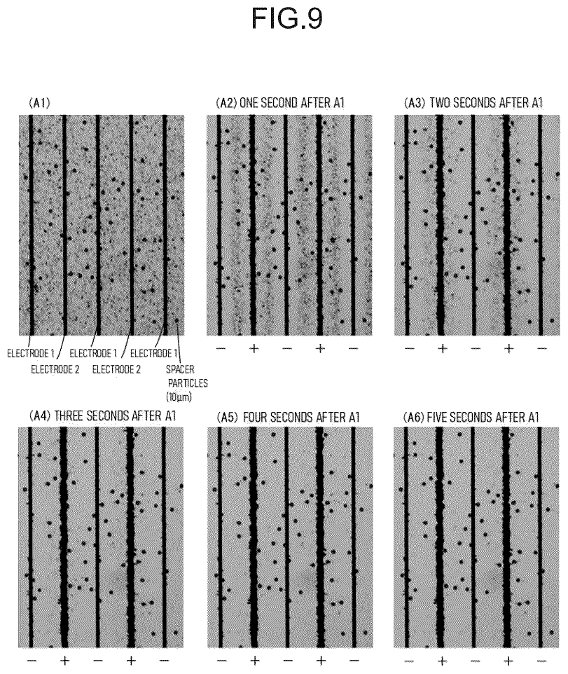

Then, voltages of −30 V and +30 V were respectively applied to the electrodes 1 and 2, and migrating of the electric-field responsive particles 20 between the electrodes 1 and 2 was observed under an optical microscope. The photographs of the migrating are illustrated in FIG. 9. In FIG. 9, A1 illustrates a state before the voltages were applied. A2 illustrates a state one second after A1. Between A1 and A2, voltages of −30 V and +30 V were respectively applied to the electrodes 1 and 2. The application of the voltages caused the uniformly dispersed electric-field responsive particles 20 to migrate toward the electrode 2. This experiment reveals that the electric-field responsive particles 20 nearly completely agglomerated on the electrode 2 three to four seconds after A1.

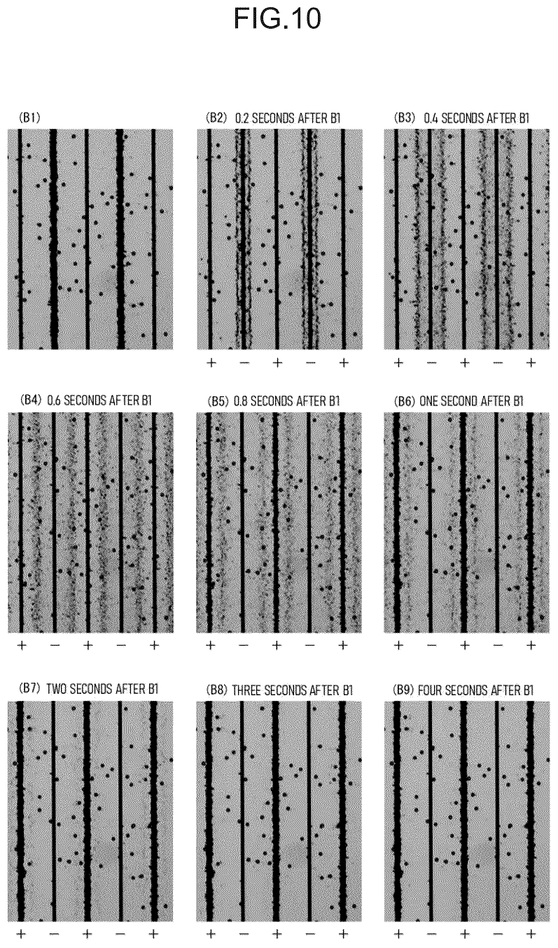

Then, opposite positive and negative voltages were applied to the electrodes 1 and 2, and migrating of the electric-field responsive particles 20 between the electrodes 1 and 2 was observed under the optical microscope. The photographs of the migrating are illustrated in FIG. 10.

In FIG. 10, B1 illustrates a state before change of the applied voltages. B2 illustrates a state 0.2 seconds after B1. The applied voltages were changed between B1 and B2, and voltages of +30 V and −30 V were respectively applied to the electrodes 1 and 2. The switch of the positive and negative voltages caused the electric-field responsive particles 20 that had agglomerated on the electrode 2 migrate simultaneously toward the electrode 1. This experiment reveals that the electric-field responsive particles 20 nearly completely agglomerated on the electrode 1 three to four seconds after B1.

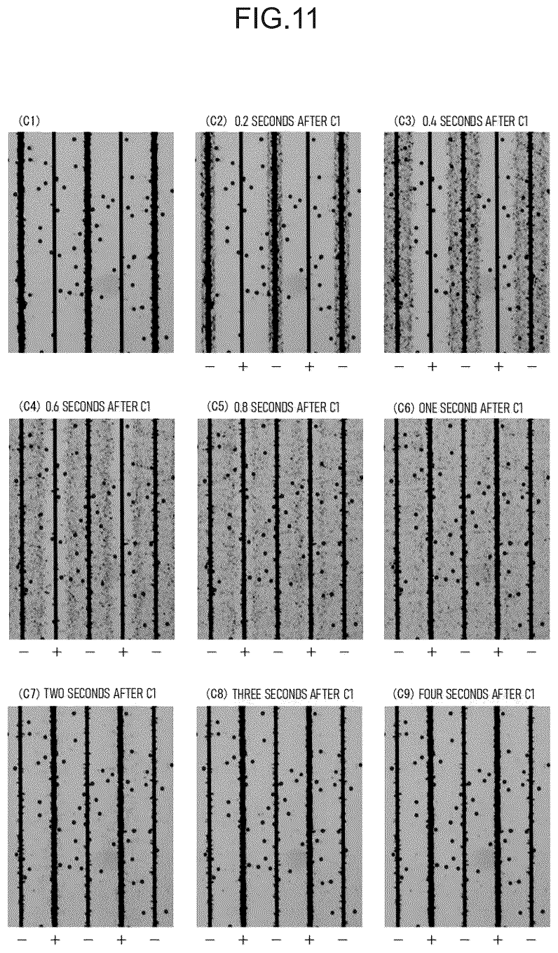

Then, opposite positive and negative voltages were again applied to the electrodes 1 and 2, and migrating of the electric-field responsive particles 20 between the electrodes 1 and 2 was observed under the optical microscope. The photographs of the migrating are illustrated in FIG. 11. In FIG. 11, C1 illustrates a state before change of the applied voltages. C2 illustrates a state 0.2 seconds after C1. The applied voltages were changed between C1 and C2, and voltages of −30 V and +30 V were respectively applied to the electrodes 1 and 2. The switch of the positive and negative voltages caused the electric-field responsive particles 20 that had agglomerated on the electrode 1 migrate simultaneously toward the electrode 2. This experiment reveals that the electric-field responsive particles 20 nearly completely agglomerated on the electrode 2 three to four seconds after C1.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An electric-field responsive particle comprising:
carbon black;
a first polymer including a functional group with a positive charge; and
a linking group connecting the carbon black and the first polymer, wherein
the linking group includes an ester group, and
the electric-field responsive particle is positively charged in a liquid medium.

2. The electric-field responsive particle according to claim 1, wherein
the functional group included in the first polymer and having the positive charge is an ammonium group or a salt thereof.

3. The electric-field responsive particle according to claim 1, wherein
the linking group is a divalent group represented by the following formula (V), 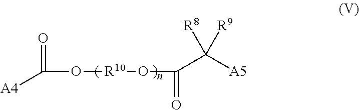
wherein R⁸ and R⁹ each independently represent a hydrogen atom, or a hydrocarbon group including no substituted group or a substituted group and having one to ten carbons, R¹⁰ represents a divalent hydrocarbon group with two to ten carbons, n represents an integer from 1 to 5, when n is 2 or more, a plurality of R¹⁰ may be identical or may be different, A4 represents a bonding hand with a surface of the carbon black, and A5 represents a bonding hand with the first polymer.

4. The electric-field responsive particle according to claim 1, wherein
the first polymer has a degree of polymerization of 10 to 1,000.

5. An electric-field responsive particle comprising:
carbon black;
a first polymer including a functional group with a positive charge;
a linking group connecting the carbon black and the first polymer; and
a second polymer laminated on the first polymer and including a functional group with a negative charge, wherein
the linking group includes an ester group,
the second polymer is electrostatically adsorbed to the first polymer, and
the electric-field responsive particle is negatively charged in a liquid medium.

6. The electric-field responsive particle according to claim 5, wherein
the functional group included in the second polymer and having the negative charge is a carboxylate group, a sulfate group, a sulfonate group, a phosphate group, a phosphonate group, or a salt thereof.

7. An electric-field responsive particle comprising:
carbon black;
a first polymer including a functional group with a positive charge;
a linking group connecting the carbon black and the first polymer;
a second polymer laminated on the first polymer and including a functional group with a negative charge; and
a third polymer laminated on the second polymer and including a functional group with a positive charge, wherein
the linking group includes an ester group,
the second polymer is electrostatically adsorbed to the first polymer,
the third polymer is electrostatically adsorbed to the second polymer, and
the electric-field responsive particle is positively charged in a liquid medium.

8. A manufacturing method of the electric-field responsive particle according to claim 1, the manufacturing method comprising:
converting a carboxyl group on a carbon black surface to a polymerization initiating group including an ester group; and
synthesizing a first polymer including a functional group with a positive charge by initiating a polymerization reaction from the polymerization initiating group.

9. The manufacturing method according to claim 8, wherein
the converting includes converting the carboxyl group on the carbon black surface to an acyl chloride group (—COCl) and then performing a reaction represented by the following scheme, 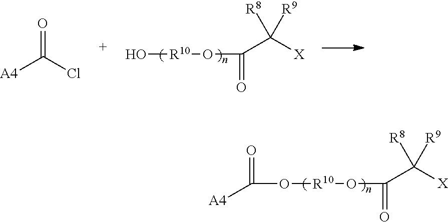
wherein R⁸ and R⁹ each independently represent a hydrogen atom, or a hydrocarbon group including no substituted group or a substituted group and having one to ten carbons, R¹⁰ represents a divalent hydrocarbon group with two to ten carbons, n represents an integer from 1 to 5, when n is 2 or more, a plurality of R¹⁰ may be identical or may be different, A4 represents a bonding hand with a surface of the carbon black, and X represents a halogen atom.

10. The manufacturing method according to claim 8, wherein
the synthesis includes synthesizing a polymer including an amino group by using a monomer including the amino group and then converting the amino group to an ammonium group.

11. A manufacturing method of the electric-field responsive particle according to claim 5, the manufacturing method comprising:
converting a carboxyl group on a carbon black surface to a polymerization initiating group including an ester group;
synthesizing a first polymer including a functional group with a positive charge by initiating a polymerization reaction from the polymerization initiating group; and
causing a second polymer including a functional group with a negative charge to be electrostatically absorbed to the first polymer.

12. A manufacturing method of the electric-field responsive particle according to claim 7, the manufacturing method comprising:
converting a carboxyl group on a carbon black surface to a polymerization initiating group including an ester group;
synthesizing a first polymer including a functional group with a positive charge by initiating a polymerization reaction from the polymerization initiating group;
causing a second polymer including a functional group with a negative charge to be electrostatically absorbed to the first polymer; and
causing a third polymer including a functional group with a positive charge to be electrostatically absorbed to the second polymer.

13. An electrophoretic medium comprising:
the electric-field responsive particle according to claim 1; and
a solvent in which the electric-field responsive particle is dispersed.

14. An electrophoretic medium comprising:
the electric-field responsive particle according to claim 5; and
a solvent in which the electric-field responsive particle is dispersed.

15. An electrophoretic medium comprising:
the electric-field responsive particle according to claim 7; and
a solvent in which the electric-field responsive particle is dispersed.
